(19) United States
(12) Patent Application Publication
(10) Pub. No.: US 2005/0283438 A1
(43) Pub. Date: Dec. 22, 2005

(54) Video documentation for loss control

(76) Inventors: Michael L. Brownewell, Lyons, CO (US); Richard H. Bonham, Longmont, CO (US); Ann J. Mitchell, Longmont, CO (US)

Correspondence Address: RICK MARTIN;PATENT LAW OFFICES OF RICK MARTIN, PC, 416 COFFMAN STREET, LONGMONT, CO, 80501, US

(21) Appl. No.: 11/154,173

(22) Filed: Jun. 16, 2005

Related U.S. Application Data
(60) Provisional application No. 60/580,211, filed on Jun. 16, 2004.

(51) Int. Cl. H04L 9/00

(52) U.S. Cl. 705/50

(57) ABSTRACT

Systems and methods of documenting an event are disclosed. Events may include, but are not limited to, an accident, a crime, transportation of cargo, a medical procedure, a legal proceeding, an economic transaction, and/or a construction project. An event may be documented by data including, but not limited to, optical and/or audio records of the event. The event documentary may be accessible only via a database storage service bureau which has been certified to maintain accurate and authentic data by a party acceptable to a judicial system. The documentary may be admissible in a court of law. The documentary may be useful for determining the cause of an event and/or preventing a future event.

### CROSS REFERENCE APPLICATIONS

This application is a non-provisional application claiming the benefits of provisional application No. 60/580,211 filed on Jun. 16, 2004.

### BACKGROUND

The foregoing examples of the related art and limitations related therewith are intended to be illustrative and not exclusive. Other limitations of the related art will become apparent to those of skill in the art upon a reading of the specification and a study of the drawings.

Loss control has historically consisted of a series of checks and balances to guarantee the transfer and/or delivery of cargo. This was achieved by having both the delivering party and receiving party sign paper documents, each confirming the amounts and specific locations of the delivered cargo. Electronic signatures have since replaced paper documents. On Jun. 30, 2000, the Electronic Signatures in Global and National Commerce Act (E-SIGN Act) was signed to establish the validity of electronic signatures for interstate as well as international commerce.

The ability to prove actual occurrences while cargo is in the care, custody, or control of those with legal responsibility for delivering cargo often relies on witness or third-party testimony. An example is the transportation industry in the United States. In the transportation industry in the United States, typically only the operator of a vehicle provides a point-of-view statement. Following an accident, all witnesses are questioned in an attempt to determine where fault lies. Such statements are often all a court has with which to validate a participant's claim of fault or negligence of a second party. Actual event recording, based on a third party recording and storage of the event, would greatly enhance the validity of legal claims related to the event.

What is needed is a 3^{rd} party, un-biased video real-action documentation of an event. Such video documentation may present an unquestionable recount of events during court proceedings and may accurately challenge witness testimony as related to ‘cause-of-events’. What is also needed is the ability to verify pickup and delivery of any product to the intended party.

### SUMMARY

The following embodiments and aspects thereof are described and illustrated in conjunction with systems, tools, and methods which are meant to exemplify and illustrate, and not be limiting in scope. In various embodiments, one or more of the above described problems have been reduced or eliminated, while other embodiments are directed to other improvements.

Systems and methods of documenting an event or occurrence are disclosed. The documentary of the occurrence may be developed such that it is accessible only by a third party database storage service bureau which has been certified to maintain accurate and authentic data. Thus, the documentary may be admissible in a court of law. The documentary may be useful for determining the cause of an occurrence and/or preventing future occurrences.

An event trigger subsystem may be used to activate a system documenting an occurrence. The event trigger subsystem may comprise devices which automatically detect an occurrence. An example is an accelerometer which may detect a vehicular accident due to a sudden change in speed. Additionally, an event trigger subsystem may comprise manually or remotely activated devices.

In the event of an occurrence, encrypted data comprising the documentary of the occurrence may be saved on a local data storage subsystem. Additionally, such encrypted data may be transferred to a remote location. Other actions, such as securing cargo, may be taken in the event of an occurrence.

A smart-card system may be used to control and track cargo. By way of example and not of limitation, the smart-card system may track cargo consisting of fuel to insure it was shipped along a specific route, unloaded successfully at one or more locations, and accepted by each customer along a route.

Other features and embodiments will appear from the following description and appended claims and by referring to the accompanying drawings which form a part of this specification, wherein like reference characters designate corresponding parts in the several views.

### GLOSSARY

The following terms are defined herein and will be used consistently throughout this document to mean:

1) ‘point A’: the location and/or time that any cargo becomes a user's responsibility through written contract, by implication through customary business practice, and/or by the designation of any court of law in the territory wherein an occurrence damages the cargo.

2) ‘point B’: the location and/or time that the user relinquishes the cargo and/or the responsibilities assumed at Point A.

3) ‘cargo’: any tangible or intangible property or data, that is in user care, custody and/or control, or any tangible or intangible property or data, including money in electronic transit, that is under user direction by written contract, by implication through customary business practice, or by the designation of any court of law recognized by the government in the territory wherein an occurrence takes place. For example, cargo includes but is not limited to, funds being transferred by bank wire, credit card, or check, as well as real property, product serial numbers, batch numbers, and percentage of completion of a project.

4) ‘occurrence’: an event that results in bodily injury, property damage, property loss, loss of income due to delay in transit, damage to the cargo, or any activity interpreted as a user's responsibility by a court of law recognized by the government in the territory wherein an occurrence takes place.

5) ‘event trigger’: any action that precipitates and/or causes an occurrence.

6) ‘field of view’: the area encompassing the image recorded by a camera.

7) ‘cause of loss’: the description of an event that results in an occurrence.

8) ‘loss control’: any action that would reduce the risk and/or frequency of a loss or any action that would identify a cause of a loss.

9) ‘third party compliant’: state where a disinterested, independent party (such as a third party database storage service bureau) has certified the accuracy and/or authenticity of a process, method, good, and/or tangible or intangible property or data.

10) ‘impact sensor’: multiple “stop” mechanisms for activation of “loop start” recording, including but not limited to, an accelerometer (or alternate method of determining acceleration), deceleration or directional change outside a vehicle's normal operating characteristics, etc.

11) ‘angle sensor’: a device that determines the angle cargo is positioned at.

12) ‘temperature sensor’: a device that determines the temperature of an area of interest.

13) ‘pressure sensor’: a device that detects a change of pressure in an area of interest.

14) ‘contamination sensor’: a device that detects a change in the composition of cargo and/or an area of interest.

15) ‘panic switch’: a manual “emergency stop” switch which may be activated by a driver, machine operator, a remote party, a satellite communication protocol, etc.

16) ‘any unit’: any device that detects a change in conditions that have one or more effects on cargo and/or an area of interest, and is fully integrated into a monitoring system.

17) ‘construction related sensor’: any device that monitors and/or records changes in one or more of the following characteristics as they relate to building or construction site: temperature, pressure, moisture, noise, atmospheric contamination, motion, vibration, soil conditions, or other characteristics.

18) ‘flow sensor’: a device that determines a quantity of cargo loaded to a transport apparatus or unloaded from a transport apparatus.

19) ‘disabling substance’: any form of substance released into a contained or designated area intended to make the area hazardous, uninhabitable, or intended to disable any human in the area.

20) ‘fire extinguisher’: any device designed to contain, eradicate, or extinguish a fire.

21) ‘audio signal device’: a device that makes noise (e.g. a horn) or that can be used to transmit a voice or an audio signal.

22) ‘any device’: any device that is connected to a system and is an input device that is activated or turned on either directly or indirectly by the system, any device that adds a data field to the system, and/or any device that adds an output device. Examples include, but are not limited to, an audio recording device and an offsite audio reproduction device.

23) ‘interface switch’: any device that completes a circuit from an information processor to any device that it is connected to.

24) ‘GPS’: global positioning system which is a device designed to recognize the global position of a person or property via a system of satellites.

25) ‘transceiver’: device that communicates with an outside source; relays instructions for the protection of a person or property.

26) ‘encoder’: subsystem that encrypts data and/or allows access to stored data by a disinterested, independent third party in the event of an incident.

27) ‘decoder’: device that processes signals received from an outside source and initiates a go sequence from the instructions.

28) ‘unit 60’: Delivery, Control, and Acknowledgement (DCA) device.

29) ‘authenticate’: to verify the identity of a person, an association, an entity, an apparatus, a transaction, data, tangible property, intangible property, and/or a process.

### BRIEF DESCRIPTION OF THE DRAWINGS

Exemplifying embodiments are illustrated in referenced figures of the drawings. It is intended that the embodiments and figures disclosed herein are to be considered illustrative rather than limiting. Also, the terminology used herein is for the purpose of description and not of limitation.

FIG. 1 is a top view of a trucking application embodiment.

FIG. 2 is a side view of a crane and rigging application embodiment.

FIG. 3 is a side view of an intermodal/ocean cargo application embodiment.

FIGS. 4a and 4b are exterior and interior perspectives respectively of a commercial/industrial/residential real estate application embodiment.

FIG. 5 is a system representation of embodiments of cargo protection and controls (CPC), third party verification, and data information flow.

FIG. 6 is a system representation of sensor data and other device input as well as other device input to CPU 6.

FIG. 7 is a system representation of data flow with 3^{rd} party verification.

FIG. 8 is schematic representation of potential actions that may be taken as the result of an occurrence.

FIG. 9 is a schematic description of DCA 60.

FIG. 10 is a flow chart of the CPC systems checks.

FIG. 11 is a flow diagram showing the overall interactions for the cause of loss versus loss control procedures.

FIG. 12 is an example of an embodiment applying 3^{rd} party compliant data and storage to a medical application.

FIG. 13 is an example of an embodiment applying 3^{rd} party compliant data and storage to a legal application.

FIG. 14 is an example of an embodiment applying 3^{rd} party compliant data and storage to document a construction project.

FIG. 15a is an example of an embodiment of third party compliant data system integrated into a trucking industry application.

FIG. 15b illustrates the data flow of the system of FIG. 15a

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE PRESENT INVENTION

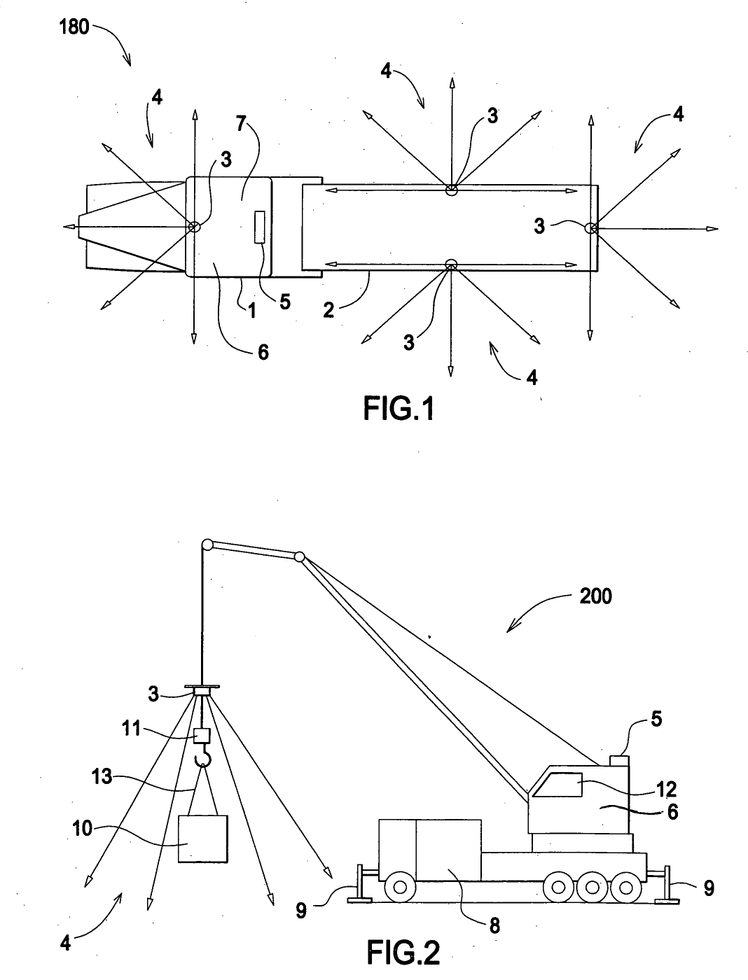

FIGS. 1-4 are schematic diagrams of possible embodiments of documentation systems and means taught herein. FIG. 1 is a top view of trucking application embodiment 180. The top view of power unit (semi-tractor) 1 and trailer 2 shows possible locations for camera(s) 3 and respective fields of view 4 of camera(s) 3. Camera(s) 3 may be capable of fields of view 4 of up to 360° depending on the application desired.

Signal transceiver 5 may be located on top of the truck cab of power unit 1. Signal transceiver 5 is a device capable of transmitting and receiving data to/from a remote location and may be connected to a CPU 6 (Central Processing Unit/Data Recorder). CPU 6 may be located in the cab of the power unit 1 (and/or at a remote location). On-board controls 7 may also be located in the cab of power unit 1.

FIG. 2 is a side view of crane and rigging application embodiment 200. The side view of a crane unit 8 with outrigger supports 9 shows cargo 10 being maneuvered. Possible locations for camera(s) 3 and respective field(s) of view 4 of camera(s) 3 are illustrated. One possible location for a camera 3 is just above crane hook assembly 11 for possible view of cargo 10 and rigging 13. Camera(s) 3 may be capable of fields of view 4 of up to 360° depending on the application desired. On top of the cab of crane control center 12 may be signal transceiver 5, which may be connected to the CPU located in the cab (and/or a remote location) of crane control center 12. The on-board controls may also located in the cab of the crane control center 12.

FIG. 3 is a side view of intermodal/ocean cargo application embodiment 300. The side view of flatbed truck 14 shows cargo container 15 secure on the bed of the truck. Possible locations for camera(s) 3 and the respective field(s) of view 4 of cameras 3 are illustrated. Camera(s) 3 may be capable of fields of view 4 of up to 360° depending on the application desired. Signal transceiver 5 may be located on top of the cab of flatbed truck 14 and/or on top of cargo container 15. Signal transceiver 5 may be connected to CPU 6 which may be located in the cab of flatbed truck 14. On-board controls 7 may be located in the cab of the flatbed truck 14

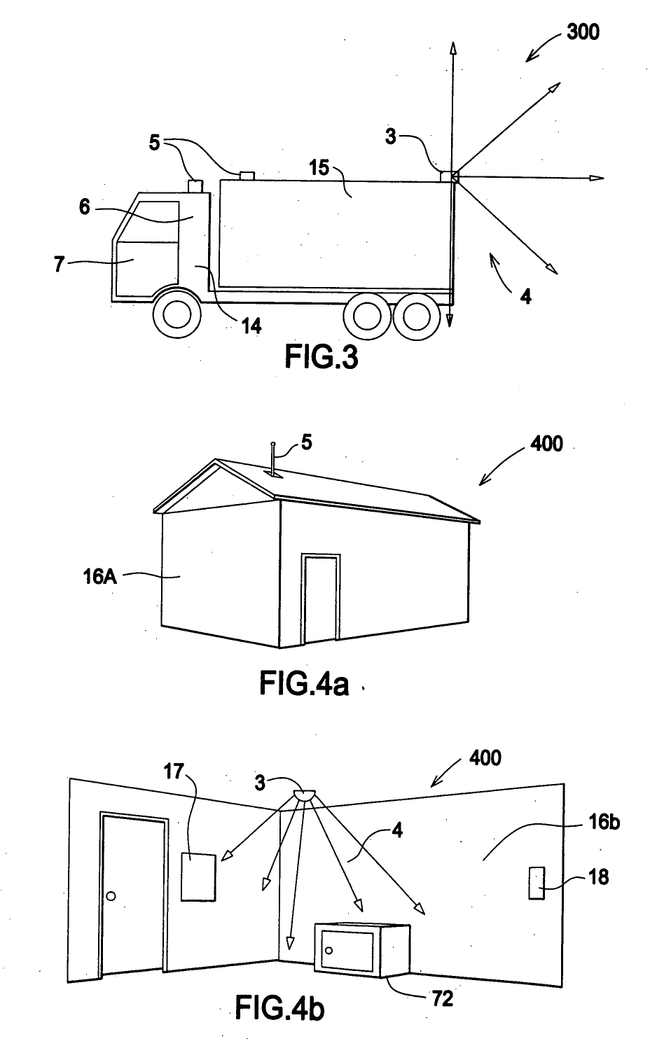

FIGS. 4a and 4b are exterior and interior perspectives respectively of commercial/industrial/residential real estate application embodiment 400. FIG. 4b is a side view of a structure 16b showing the location of security alarm panel 17. By way of example and not limitation, safe 72 may be secured. Possible locations for camera(s) 3 and respective field(s) of view 4 of camera(s) 3 are also illustrated. Camera(s) 3 may be capable of fields of view 4 of up to 360° depending on the application desired.

FIG. 4a shows an exterior perspective view of structure 16a. Signal transceiver 5, which may be in communication with a security monitoring firm, may be located on top or in the attic of structure 16a. Signal transceiver 5 may be connected to CPU 18. CPU 18 may be incorporated into the security alarm panel 17 or may be a stand alone device.

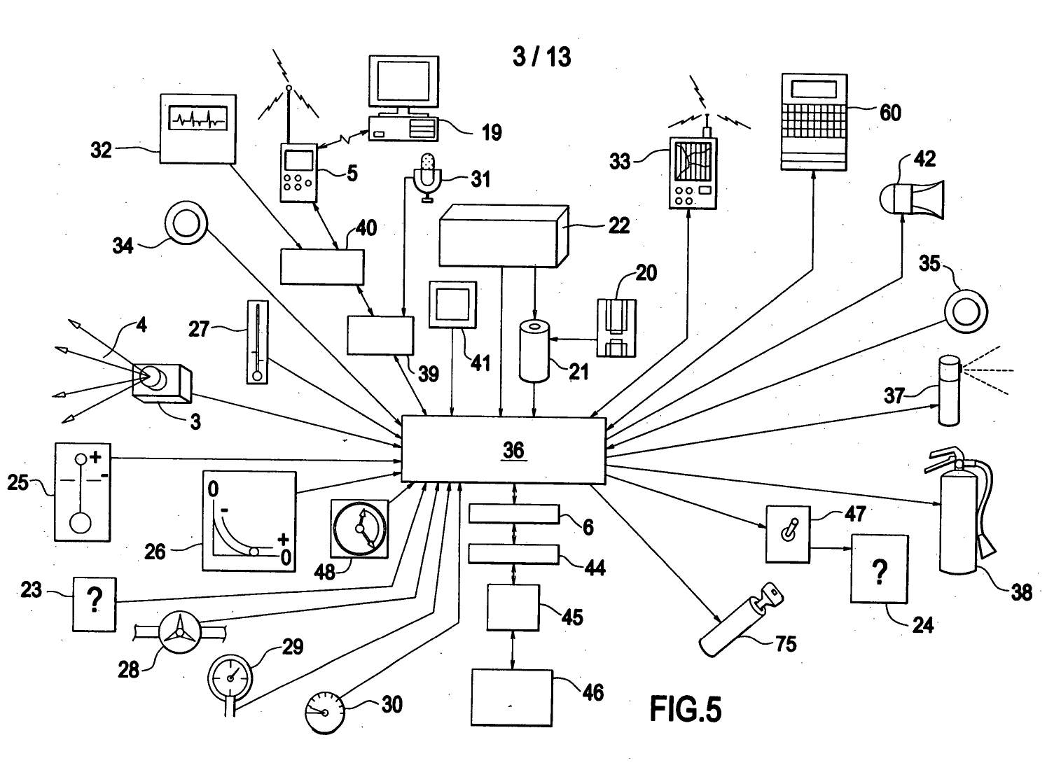

FIG. 5 is a system representation of embodiments of cargo protection and controls (CPC), third party verification, and data information flow. It should be understood that a plurality of embodiments are possible which may comprise some, all, or none of the elements of FIG. 5. Additionally, an embodiment may comprise a single or multiple occurrence of a given element.

FIG. 5 illustrates various types of hardware units and processes. Some may have one way flow while others may have two way flow as will be noted. Data from units may initially flow into interface 36.

The units may have three potential sources of power. External power 20 may come from a vehicle or other mobile source or a fixed power distribution or generation system. Solar panel 22 may be used as a primary or secondary source of power. Also, battery 21 may be used as a primary or redundant backup source of power and may be recharged via external power source 20 or solar panel 22.

The following units may have a one way data/energy flow into interface 36: battery 21, camera 3, on-site panic button 34, any additional input unit 23, impact sensor 25, angle sensor 26, temperature sensor 27, flow sensor 28, pressure sensor 29, atmospheric sensor 30, audio input recorder 31, date and time stamp 48, and/or input from medical devices 32. The following units may have a one way data flow received from interface 36: any additional output unit 24 (which may be controlled by switch 47), mace or disabling substance dispenser 37, fire extinguishing device 38, camera monitoring device 41, and/or audio device 42. The following may have 2-way data flow with interface 36: transceiver 5, on-site CPU 6, GPS unit 33, external command panic button 35, encoding device 39, decoding device 40, and/or delivery, control and acknowledgement device 60.

Video images may travel from respective camera 3, to interface 36 and onto on-site CPU 6. When appropriate, the images may be encrypted 44 as either stills or as full motion images and saved to recording device 45. Stills or full motion images may be selected based on the occurrence type and user specifications. Also, if programmed, the data will be forwarded 46 on to an external source (e.g. a security monitoring station) for immediate action. Data inputs may flow through interface 36 and into CPU 6 for programmed instructions and/or responses.

Certain commands and/or responses can be issued from external source 19 through transceiver 5, into interface 36 and onto on-site CPU 6. At CPU 6, instructions can be given back through interface 36 to execute various procedures. For example, instructions can be given to utilize audio device 42, introduce a disabling substance into a specified environment 37, and/or kill the ignition 75 in the cases of robbery or hijacking. For security reasons, instructions can be encoded 39 at the on site location prior to transmission to off site location 19, and decoded 40 once they arrive back on site.

Should a triggered incident occur, the encrypted data stored in recording device 45 may only be accessible to ‘independent’ 3^{rd} parties. An independent third party may be a database storage service bureau which has been certified to maintain accurate and authentic data by parties such as law enforcement, the judicial system, and other interested parties. By way of example and not of limitation, a party which certifies that a database storage service bureau maintains accurate and authentic data may comprise individuals acceptable to a government law enforcement agency, and/or a judicial agency, and/or an insurance industry trade group.

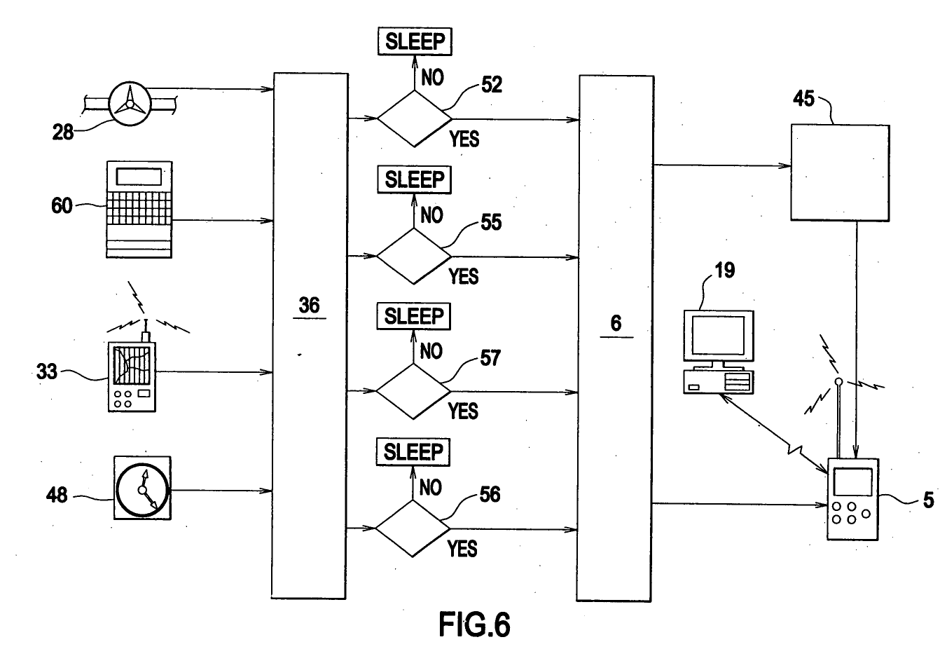

FIG. 6 is a system representation of sensor data and other device input as well as other device input to CPU 6. Flow data from flow sensor 28, or data from another sensor, may go into interface 36 when activated 52. At all other times, sensors may be in sleep mode to save energy. Data may flow from interface 36 to on-site CPU 6 and if programmed, onto recording device 45. Data may further flow onto external control center 19 via transceiver 5.

In the event Delivery/Control/Acknowledgement DCA unit 60 is activated 55 and/or GPS 33 is activated 57, the same procedure discussed above with respect to flow sensor 28 may be followed. For the purpose of this illustration, clock 48 is shown to represent the time/date stamp that may be attached to some or all data when activated 56. However, the time/date stamp function may be provided by hardware and/or software in CPU 6 at the time of data transfer from interface 36 to CPU 6.

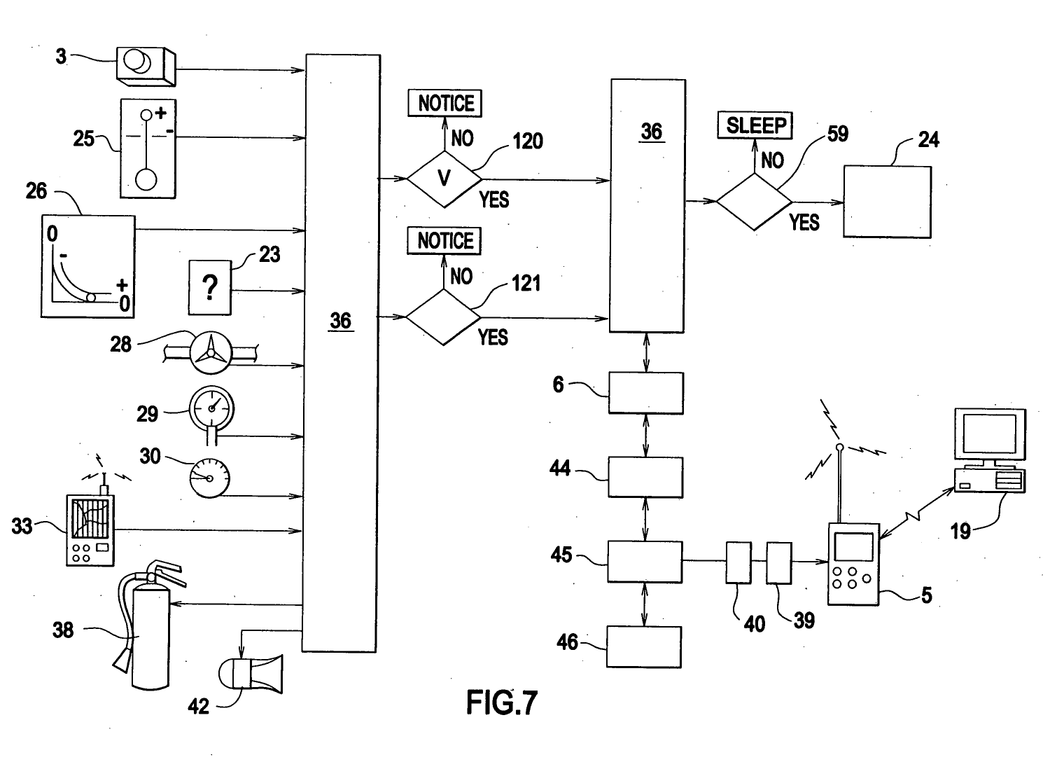

FIG. 7 is a system representation of data flow with 3^{rd} party verification. At activation, camera 3 images, if not digital may be converted to digital format. If the images are not corrupt, they may be sent to CPU 6. The images may be encrypted 44 and then sent onto recording device 45. The images may further be sent to external control center 19 via transceiver 5 after optional encryption by encoder 39. External control center 19 may further review the images, analyze the images, and/or respond to the images in the form of command requests. If the images are corrupt, a malfunction notice may be sent to the appropriate party.

At activation (e.g. 3, 25, 26, 28, 29, or 30) of any sensor or any additional device 23 that requires an action be taken, recorded, or transmitted, the camera image 120 or data information 121 may be converted to appropriate signal quality. If the data is not corrupt, it may be sent to CPU 6. The data may be encrypted 44 and then sent onto recording device 45. The data may further be sent to external control center 19 via transceiver 5 after optional encryption by encoder 39. External control center 19 may further review the data, analyze the data, and/or respond to the data in the form of command requests. If the data is corrupt, a malfunction notice may be sent to the appropriate party. Individuals at external control center 19 may send commands via transceiver 5 within their directives and authority if in their discretion they believe action is required based on information received from the site via transceiver 5. The commands may then be decoded 40 and sent on to CPU 6. The instructions may then be given to the various output devices via interface 36 and appropriate action may be taken (e.g. horn 42 sounds, a fire extinguishing device 38 is activated).

The following is an example of a possible embodiment of a system for documenting a loss in a vehicle or involving a vehicle. Such embodiment is referred to as a TR-ED in the following example. It is to be understood that the following embodiment is offered solely by way of example and not of limitation. Various other embodiments of a system for documenting a loss in a vehicle or involving a vehicle are possible.

A small, easily installed video capture device may be installed inside the cab of a vehicle or other equipment. It thus provides a real time recording and encoding system. The device is referred to as “TR-ED” (Time Recording and Encoding Device) throughout this example. The fixed, forward facing camera will provide a view of the road consistent with that of the operator's field of view which is the vehicle's trajectory. An on-board digital video recorder will continually “loop” the live video shot to its hard drive, only maintaining that video signal upon activation of a “go” sequence. The “go” sequence may be any one of multiple events, which take place within the vehicle or an incoming signal to the vehicle via satellite communication (sat-com). This process will secure a desired real-time video of an incident in the present invention's on board memory for future analysis by an Authorized Third Party (ATP). The keys to this embodiment's performance are that the device must be small enough not to impede the driver's or operator's field-of-view when installed inside the vehicle or other equipment (glass, visor, dash, etc.). Specific considerations will be given to its current consumption, operating voltage (e.g. 6V -30VDC), and ease of installation. It is understood that there may be a wide range of operating protocol for the device including: continuous operation, vehicle-on operation, remote-on operation, etc. Consideration will be provided during design for various “on/off” scenarios. The physical characteristics of the device must be rugged enough to provide protection from: vehicle accident, shock, extreme heat and cold (−60° F. to +200° F.), water, and fire. An internal battery backup must be provided with duration sufficient to continue the post-alarm in the event of battery termination resulting from impact, fire or other.

The system must run a “go” sequence consisting of pre and post alarm duration. The system will continuously record activity in loop increments (duration to be discussed later). Following the activation of the “loop start” function, the unit will continue to record for a 50% interval, then archive the incident file in its entirety.

Versions of the device can include: a fixed interval—single event system (FISE); a variable interval—single event system (VISE); and a variable interval—multiple event system (VIMS).

A. FISE—documents a single event upon activation of the “go” sequence. The continual twenty-(20) minute loop will save ten-(10) minutes from the pre-alarm and continue to run for ten-(10) minutes from the post-alarm. If the video monitoring subsystem is disabled by the occurrence, then all of the storage subsystem memory (nominally 20 minutes) is used to store pre-event data.

B. VISE—documents a single event upon activation of the “go” sequence. The user selectable duration of ten-(10) minutes to sixty-(60) minutes can be programmed into the non-volatile memory prior to deployment of the device, and will perform similar to the FISE after activation.

C. VIMS—documents multiple events upon activation of the “go” sequence. The system will program and perform similar to VISE, with the added benefit of logging multiple events as files on the hard-drive (the actual number of events and duration will depend on duration of each respective “go” sequence). While running a documentation sequence, the VIMS will ignore additional commands to activate the “go” sequence. Only at the conclusion of a respective sequence will the device accept an additional “go” command.

Multiple “stop” mechanisms for activation of “loop start” recording may include the following: an accelerometer (or alternate method of determining acceleration, deceleration or directional change outside a vehicle's or equipment's normal operating characteristics), a manual “Emergency Stop” pushbutton for operation by a driver or an operator, a satellite communication protocol, etc.

A variable-frame-rate (VFR) compensation system can be integrated to the device by its internal software system in an effort to conserve storage space and provide optimum image quality at the time of incident. Using a software enabled pre-event alarm sequence, the system will automatically recall and save images, for example, five seconds prior to a stop sequence at a rate of up to about 30 frames-per-second (fps). The system will continue to conserve five seconds following the stop event at this high-resolution, then return to a rate of five frames per second. The ramp-up frame rate during an incident will dramatically improve the possibility for positive vehicle or equipment identifying information (license plate) gathering during the critical prior and post incident seconds. Changes in timing can easily be programmed.

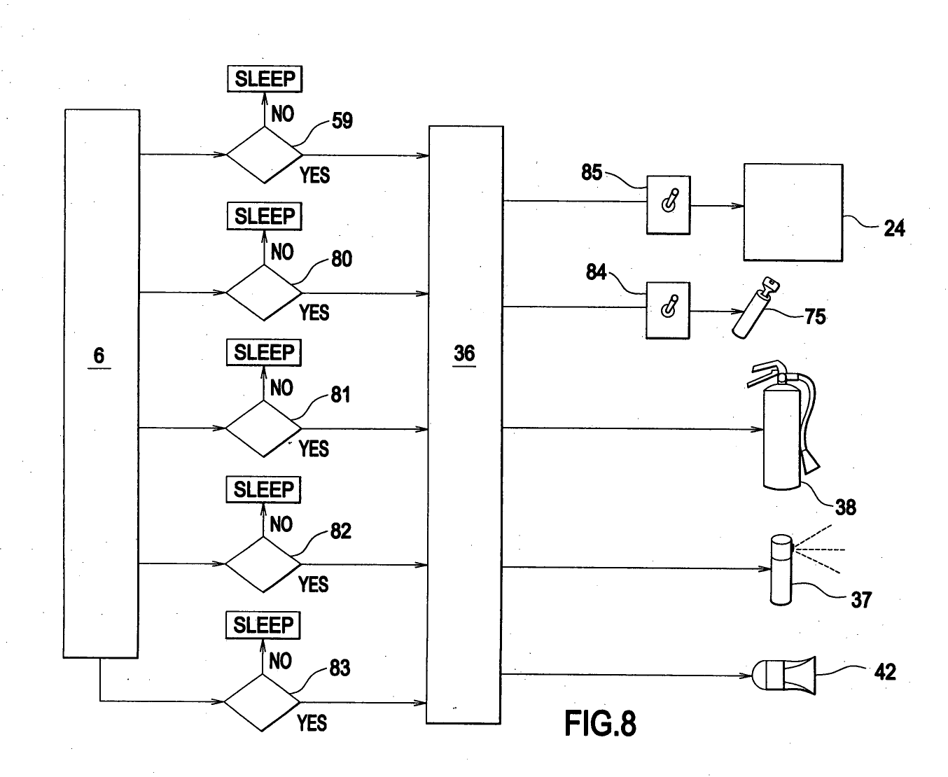

FIG. 8 is schematic representation of potential actions that may be taken as the result of an occurrence. FIG. 8 expands on the description of FIG. 7. Once a command arrives back on site and is in CPU 6, the go order may arrive at interface 36 and the appropriate action sequence may be initiated. By way of example and not of limitation, an appropriate action sequence may comprise one or more of the following: vehicle ignition termination 80 through off/on switch 84 disabling ignition 75 via remote panic button protocol 35, fire extinguishing commences 81 using associated device 38, release of disabling substance 82 begins per use of device 37, noise 83 is used through horn or siren 42, or activation/deactivation 59 or other action is commenced 85 using any other output unit 24.

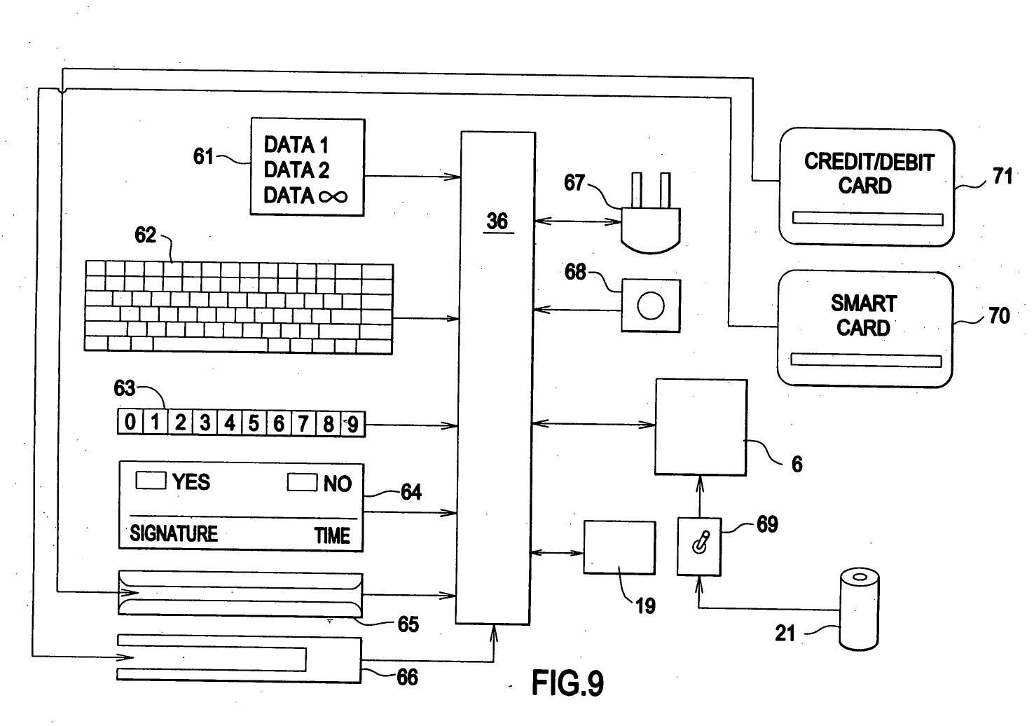

FIG. 9 is a schematic description of DCA 60, which is a remote data entry system for cargo identification, acceptance/rejection verification, payment input, and various smart card functionalities. DCA 60 is a hand held device that verifies the delivery, control, and acknowledgement of the receipt of cargo. DCA 60 may also accept credit card 71 payment 65 and any data input from a smart card 70. Data from smart card 70 may be used to complete the delivery, identify the sending and/or receiving party or transfer the cargo to another shipper for final delivery. DCA 60 may also be connected to Interface 36 directly through the interface connection plug 67 with CPU 6 or an external CPU 19. DCA 60 may incorporate a date input from an alpha key board 62, a numeric keyboard 63, an electronic signature and order spot 64 for acceptance or rejection of the order 64, and/or a credit card payment swipe 65. DCA 60 may transfer the information recorded in a smart card 70 into a data base through the smart card insert 66. This input information, along with any other information regarding the cargo from the internal CPU 6 and/or an external CPU 19, may be displayed for customer verification in LCD display 61. The displayed information may then be acknowledged by the recipient and the transaction may be verified and tracked for 3^{rd} party verification by activation of the final verification acknowledgement indicator 68. DCA 60 may be powered by internal battery 21 via switch 69.

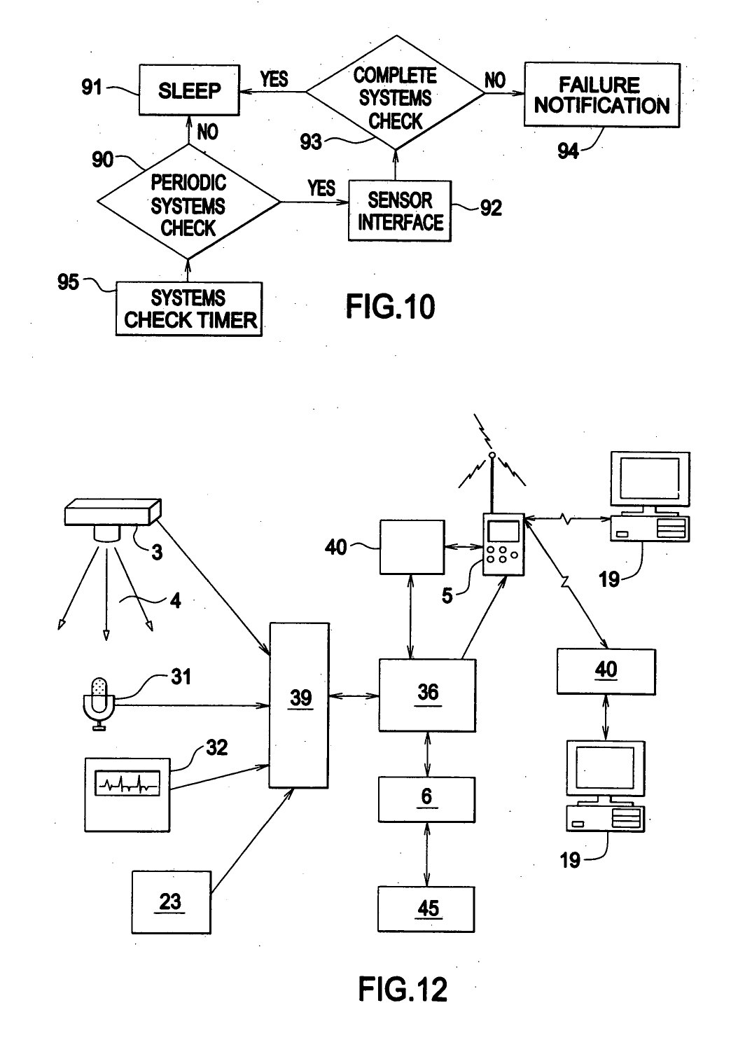

FIG. 10 is a flow chart of the CPC systems checks. FIG. 10 describes the flow of system checks internal to the system that may be performed on site or remotely. These checks are designed to verify functionality of individual units on a regular basis so as to correct problems prior to any possible incident/occurrence or allow the replacement of the units as necessary. Additionally, the CPC systems checks may notify an administrator at once in the event of any malfunction. Timer 95 can optionally enable periodic system check 90 to run, or system check 90 can have programmable activation. Periodic system check 90 may run periodic diagnostics. If activated, the system monitors sensor interface 92. A complete system check 93 may then performed. If the result of the check is ‘ok’ (yes), a return may be done into sleep mode 91. In not, a cause failure notification 94 may be sent to the system monitor.

FIG. 11 is a flow diagram showing the overall interactions of the cause of loss versus loss control procedures. An end user 102 places an order 103 into a main control system 101. The order is verified 113 by a third party. Main control system 101 then generates invoice 104, which is verified 114 by a third party, and sent to distributor 105. Distributor 105 ships inventory, which is verified 116 by a third party, along with an invoice for billing 107, to end user 102. End user 102 then sends payment 110, which is verified 111 by a third party, to distributor 105. Once payment 110 is received by distributor 105 and verified 115 by a third party, bank wire 106 is verified 112 and sent to main control system 101 which routes payment 109 to central bank 108. End user 102 receives product 118, which is verified 117 by a third party.

FIG. 11 thus illustrates a basic distribution/tracking model or system of secure components that form an integrated solution to the problem of 3^{rd} party compliance for tracking. The system may track goods and data such as manufactured goods, percentage of completion of construction projects, completed construction projects, purchase agreements/contracts, services and/or associated products. For example, a 3^{rd} party (e.g. a specified agent not associated with any manufacturer, distributor, or contractor) will provide hosting and maintenance of a server facilitating tracking. A security certification agency not associated with the hosting agent, manufacturers, distributors, and/or contractors may ensure transaction security between manufacturers, distributors, and/or contractors through the issuance of a security certificate reviewed and renewed annually. In the case of manufactured products, an E-commerce infrastructure may have a custom database design and implementation for the storage of information relating to the tracking of manufacturer's products, shipping tracking information, and distributor's receipt of goods. A database may also track purchase orders and receipt of payments for exportation to other software products (e.g. spread sheets). A client software application may facilitate the entry of manufacturing and shipping information for products of manufacturers' clients. The software application also may facilitate the entry of shipping receipts for manufactured goods and the generation of purchase order requests. Software may also be available for a custom design and implementation of infrastructure required for ordering and purchasing a manufacturer's products online via a website.

A Distributor's Web-interface to E-commerce infrastructure may exist as a custom design with a minimum of templates for interfacing with the E-commerce infrastructure. Services for integrating distributor web-interfaces into the E-commerce infrastructure may also exist for support and maintenance of distributor web-interfaces.

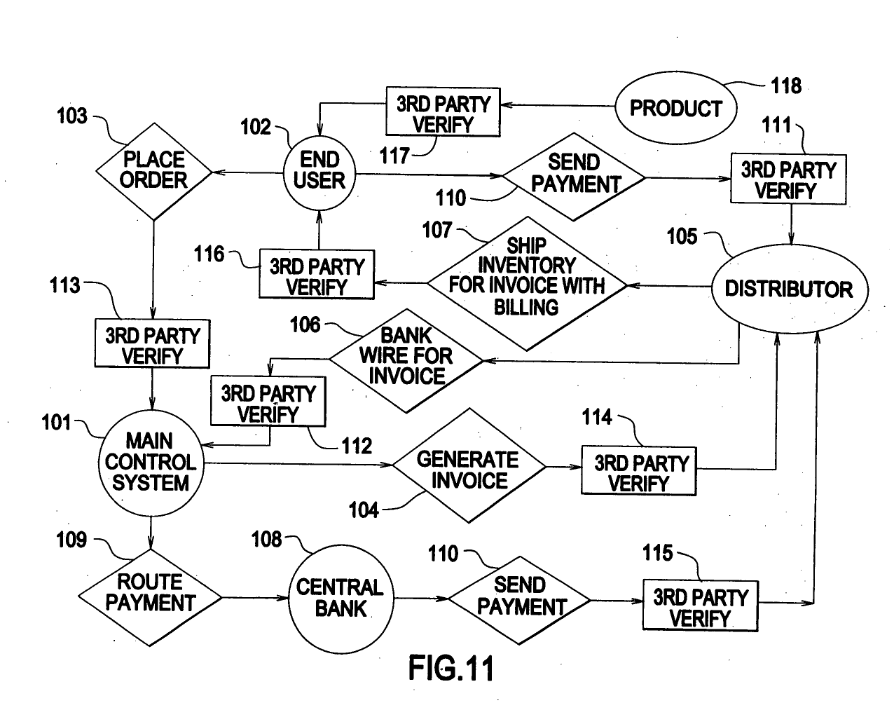

FIG. 12 is an example of an embodiment applying 3^{rd} party compliant data and storage to a medical application. This embodiment integrates fields of view 4 images from camera or optical device 3 and audio 31 to a medical profession application. The process may start with the video and audio recording of the pre-surgery interview between a patient and a doctor. The doctor may outline the treatment, operation, expected result(s), and recovery. In the process, the doctor may address all concerns of the patient and releases may be executed. This information may be encoded 39 and stored 45 in a manner referencing the patient's file number or other identification number. During the operation, all video camera and optical device 3 signals, their field of view 4, monitoring equipment 32 signals, and audio 31 signals may be recorded. The data may be encoded 39, transmitted to interface 36, transmitted to central processing unit 6, and then stored 45 in a manner such that it is referenced to the patient's identification number. In the event that the operation is to be viewed live by a group of off-site medical students or consulting physicians, the data can be decoded 40 and transmitted 5 to an off-site CPU 19 for viewing. If the operation requires the assistance or supervision of an off-site doctor who is participating or instructing and/or in the event of an emergency, the encoded data can be sent directly by the transceiver 5, decoded 40, and viewed 19. In the event that patient information needs to be reviewed prior to the operation or included in the 3rd party verified data, the information can be down loaded by involved off-site parties who have permission and are connected through an additional input unit 23. During the patient's recovery or rehabilitation, some or all of the information that may be relevant to that patient's condition such as test results, prescription relief and so forth, may be electronically recorded, encoded, stored, and referenced to the patient's identification number. In the event of complications, the entire file can be accessed to evaluate the treatment and to review the operation and the patient's rehabilitation. In the event of litigation by the patient, the entire file may be admissible as evidence. The encoded copy of the file may be decoded, certified, and forwarded to both sides of the litigation and the court. The fact that the patient's data file is encoded may help insure that the patient's medical history privacy will be maintained. Additionally, the patient's encoded data file may allow a second opinion to be offered from a remote location, may be used as a source of emergency medical data (even if the patient is at a remote location), and may be used to assist the patient with their own records and questions regarding their health.

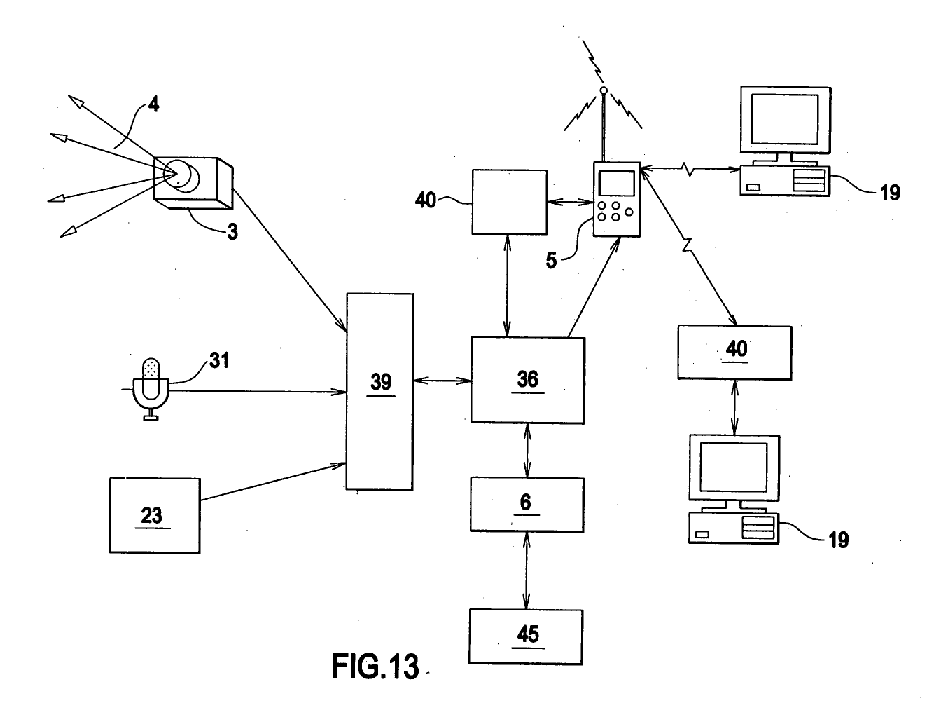

FIG. 13 is an example of an embodiment applying 3^{rd} party compliant data and storage to a legal application. This embodiment integrates fields of view 4 images from camera or optical device 3 and audio 31 to a legal profession application. The current standard for depositions is for legal proceeding data to be transcribed by a court recorder. With the introduction of encoded 3^{rd} party compliant data, the entire deposition can be viewed in real time and/or at a later time. The video image of the deposition, through camera 3, records non-verbal communication in its field of view 4. Audio 31 records all of the off-the-record motions and discussions as well as the on-the-record record motions and discussions. Any pertinent computer generated or scanned documents can be connected through additional unit input 23. The data may be encoded 39, stored 45, and made available to review. Data may be transmitted in real time or a later time to a remote location via transceiver 5. When data is transmitted to a remote location via transceiver 5, it may be decoded 40 and viewed through CPU 19, or the data may be decoded 40 and transmitted via transceiver 5 to CPU 19 for storage and retrieval at a later date. The set up and compliance to evidentiary standards can be performed by any certified court reporter.

The end result may be one edited copy with the off-the-record motions deleted from both the audio 31 and video field of view 4 signals for court and evidence use. Additionally, a non-edited copy may be provided which includes all video and audio recordings. The non-edited copy may be available to both plaintiff and defense attorneys. In summary, the video and the audio data may be combined in a format that follows federal rules of evidence. It may be encoded to guarantee validity and originality. It may be decoded and certified by an independent, third party prior to review by any governmental entity, court system, arbitrator, or other party that requires 3^{rd} party verification of the validity and authenticity of data.

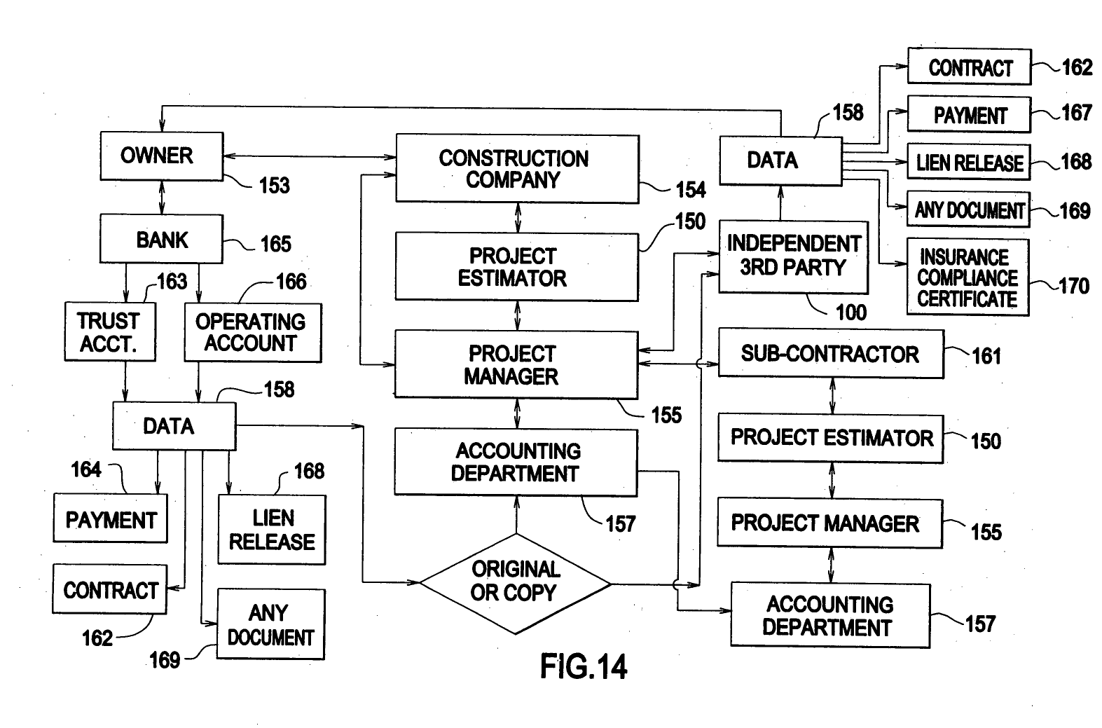

FIG. 14 is an example of an embodiment applying 3^{rd} party compliant data and storage to document a construction project. It is to be understood that the following embodiment is offered as an example and should not be construed as a limitation. An owner awards a contract to a construction company for construction of a project. The contract is the legal framework that sets terms, which may include, but are not limited to, payment requirements, documentation required to substantiate work performed, compliance to codes and regulations, and methods for dispute resolution.

Supervision of the project and contract management is turned over to the project manager of the construction company. The project manager may execute one or more separate contract(s) with subcontractor(s) for work that they will perform. The management of the prime contract and all subcontracts is the responsibility of the project manager, who shares relevant data with parties who have a vested interest in the project. By way of example and not of limitation, such parties may include:
1) Owner(s),
2) Subcontractors,
3) Banks and/or trust departments, and/or
4) Independent Third Parties.

The information to be shared by the project manager may be encoded. It may be shared utilizing proprietary access codes functioning to give particular parties log-on ability to their respective relevant data, which may be updated in real time via the project manager and/or the accounting department. All access may be granted on a permission basis dependent on a party's responsibility to the project. Access may be limited to selected data. Additionally, permission to edit or add to existing data may be given.

Project data may begin to accumulate when the project commences and may continue to amass until project completion. Every transaction involving the project data may be recorded and encoded to provide a virtual paper trail. The project data may be subject to review by various parties based upon their level of permission. By way of example and not of limitation, the data reviewed may be any or all of the following:
1) Pay Request
2) Payment(s)
3) Lien Releases
4) Change Orders
5) Audits and Analysis and Final Adjustments
6) Final approvals(s) and sign-off
7) Warranty

By utilizing a 3^{rd} party tracking and compliance system, all projects may be capable of virtual seamless integration between contract administration, estimating, accounting, and project management, as well as all related contributors, e.g. legal, insurance, surety, banking, etc. This 3^{rd} party integration may enable and enhance independent and verifiable tracking, monitoring, compliance, and audit functions.

In the event of a latent defect, all the encoded and relevant information may be available to the appropriate parties. This is especially important to a surety in the event of a claim made after the completion of the project, but within the warranty period. Parties and/or circumstances contributing to the latent defect can be identified by the independent 3^{rd} party to allow for timely resolution as set out in the contract document(s). Additionally, the third party compliant project data may be admissible as evidence in court.

The following is an illustration of the information flow in a possible embodiment of a method of using a third party compliant data management system to document and track construction management. It is to be understood that other embodiments of using a third party compliant data management system to document and track construction management are possible.

Construction project estimator 150 prepares a cost estimate for construction of the specific project. Owner of the project 153 awards project contract 162 to construction company 154 that employs construction project estimator 150. The direction of the project and contract management is then turned over to project manager 155, who is employed by construction company 154. In turn, project manager 155 executes one or more contract(s) to subcontractor(s) 161 for work they will perform, and is responsible for the management of these contracts and subcontractors. All project information data flows to and through project manager 155.

Project manager 155 confirms all work that has been completed and forwards the information to independent 3^{rd} party 100 for verification. The same information is sent to accounting department 157 to be billed. Once verified, independent 3^{rd} Party 100 prepares a request for payment 167, obtains signed lien releases 168, and forwards them to owner of the project 153. Owner of the project 153 authorizes bank 165 to make payments 164. Depending upon the terms set forth in project contract 162, funds are paid from either operating account 166, or 3^{rd} party trust account 163. A copy of payments 164 is sent to accounting department 157, and independent 3^{rd} party 100.

In some instances, independent 3^{rd} party 100 sends request for payment 167 to owner of the project 153, who then sends lien releases 168 to project manager 155 for signature. When received, a copy is sent to the independent 3^{rd} party and owner of the project 153 who authorizes bank 165 to release payments 164. A copy of payments 164 is sent to accounting department 157 and independent 3^{rd} party 100. In no case will payments 164 be made without signed lien releases 168.

As the project progresses, independent 3^{rd} party 100 begins to integrate project information data 158, tracking, contract compliance documents, and any other documents 169 relevant to completion. Independent 3rd Party 100 will maintain insurance compliance(s), monitor certificates of insurance, and administer insurance compliance audit programs.

In the case of construction projects, by utilizing the project manager as the hub for all information flow and all job related activity, projects will be capable of virtual seamless integration between contract compliance, estimating, accounting and all related 3^{rd} party contributors. This 3^{rd} party integration will enable and enhance independent and verifiable tracking, compliance and audit tasks.

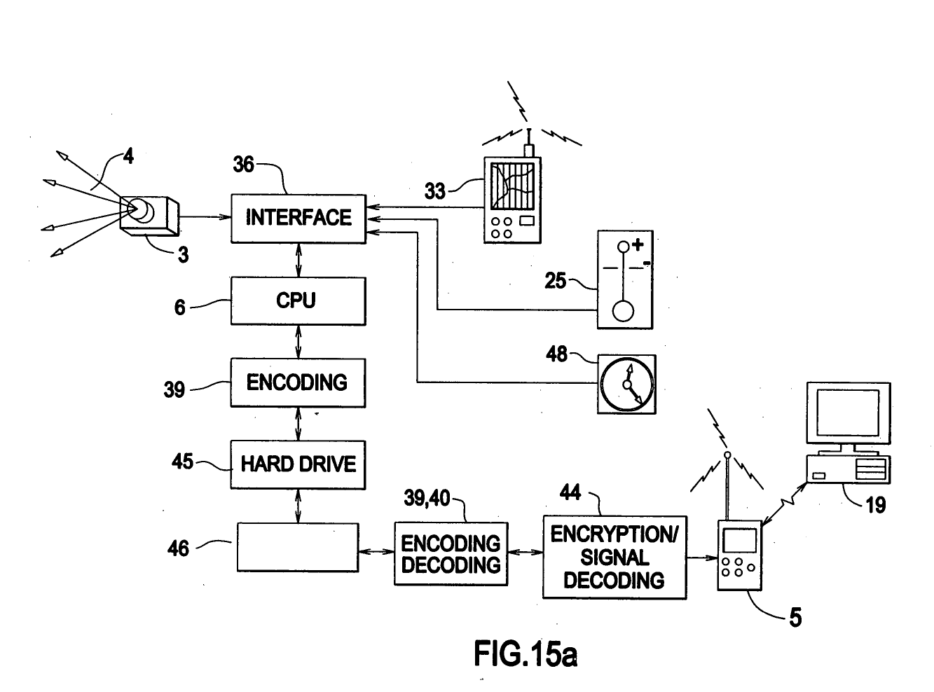

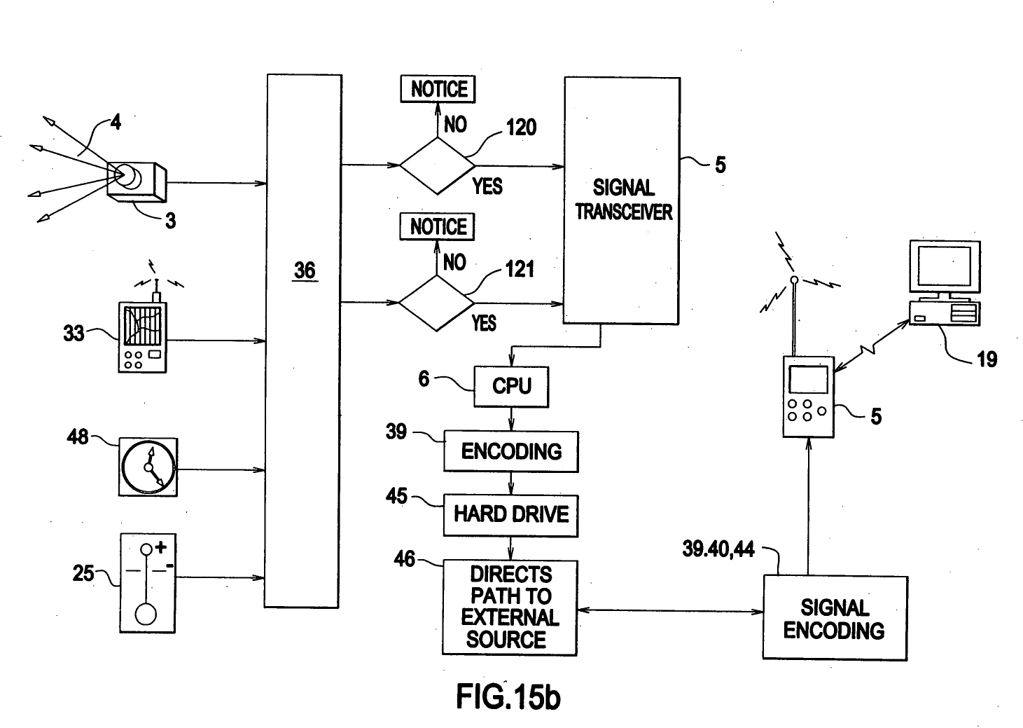

FIG. 15a is an example of an embodiment of a third party compliant data system integrated into a trucking industry application and follows the diagram of FIG. 1. The system in this example is referred to a V-RAD unit, and comprises interface 36, camera 3, field of view 4, GPS locator 33, date and time 48, and the impact sensor 25. CPU 6 encodes 39 the data and stores the data in the hard drive 45. The hard drive continuously records the data in a loop until such time as the impact sensor 25 is activated. At that point, data recording device 45 records the encoded data until the data loop has record the specified time in the software program or recording time setting. At any point in time, the encoded data in the hard drive can be downloaded and directed 46 into the encryption transmission signal coding 44, and transmitted through the signal transceiver 5 for storage in the offsite CPU 19 or decoding in the event of an occurrence to start the 3^{rd} party verified data analysis and introduction as evidence.

FIG. 15b illustrates the data flow of the system of FIG. 15a. Data from camera image 120 and data from information sensors 121 is routed through the signal transceiver 5, CPU 6, and encryption/signal coding 44. In the event of live transmission to off site CPU 6, the data is routed for direct transmission through signal transceiver 5 to off site CPU 19, or is encoded 39 and routed to hard drive 45 for storage. The data in the hard drive is continually being rewritten until the data is directed to be preserved. The data can be encoded for secure transmission 39, or routed from hard drive 45 to signal transmitter 5 to the off site CPU 19.

A detail of the image resolution is to follow.

An example of a possible image resolution can be seen in Table 1 below.

TABLE 1

| | |
|---|---|
| VERTICAL RESOLUTION | 1,200 |
| HORIZONTAL RESOLUTION | 1,600 |
| | 1,920,000 |
| FPS (FRAMES-PER-SECOND) | 5 |
| | 9,600,000 |
| CAMERA/LENS CONFIGURATION | Pinhole |
| VIDEO SEQUENCE | Stop Action |
| SPEED = 60 MPH | 88 |
| FT VEHICLE TRAVELS/SECOND | 18 |
| TOTAL MINUTES | 15 |
| FLASH PROCESSOR CAPACITY | 8,640,000,000 |

Video sequence(s) access is restricted for review only by an authorized third-party (ATP). A detailed and proprietary encryption sequence may be developed for ATP analysts exclusively. The ability to guarantee authenticity is critical for the submission of the video evidence into court proceedings. The V-RAD hardware system will encrypt the video “loop” after activation, following its termination of the respective loop, the file will be archived in the on-board hard-drive. The device must then be either directly connected or remotely connected (via secure internet connection or for fixed applications inside a cab by short-range carrier—802.11b, low-power data transceiver system, etc.) to an ATP for download, decryption, review and analysis. During the decryption process, the ATP's registration number will be encoded with a “virtual water-mark” on the file for chain-of-custody purposes (including time and date of access). Only following the authorization of the ATP's registration number can the file be downloaded to CD, DVD, or analog medium as a MPEG-2 digital file. When downloading from the VIMS version of the system, the ATP will have time/date prompts from which to select scenes. Once a scene is opened, it is permanently marked with the ATP's registration number. Multiple ATP's can access the same file; each will be logged in the respective file's “virtual water-mark.”

A single software system will accompany the VISE and VIMS versions of the V-RAD, each containing a single-user license. The software will enable the customer to program the VISE and VIMS version of the system prior to installation into a vehicle. Software is projected to be a DOS base system with serial port program capability. The Analysis software will be available only to authorized ATP's who have completed the registration process. Each is a single user license and will require on-line, live activation prior to issuance of an authorization code. The ATP software will contain the decryption algorithms for video, audio, and project or product tracking retrieval and analysis, as well as standardized methods of storage and download.

A key component of the V-RAD is the development of an “Authorized Third Party” evidentiary verification system. The ATP would act as an intermediary between the owner/operator of the vehicle and the insured, providing an unbiased report pertaining to:
1. The incident, relating to causes that were either in or out of the control of the operator.
2. The pre-alarm findings, what lead-up to the circumstance and again was the operator in or out of control of the events.
3. The post-alarm findings, what events took place following the event and what were the specific actions of the operator.

The development of the ATP verification system must be a collaborative effort between the insured, law enforcement, judiciary council and various representatives from the transportation 1, crane and rigging 2, and other equipment 3 industries.

While a number of features and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

1. An event documenting system (EDS) functioning to document an event in a monitored area, the EDS comprising:
a video monitoring subsystem having an output signal representing an image of the monitored area;
an event trigger subsystem capable of detecting the event;
an encoding subsystem capable of encrypting the video monitoring subsystem output signal;
a storage subsystem capable of storing the video monitoring subsystem output signal;
a control subsystem capable of controlling the EDS;
wherein the video monitoring subsystem is continuously operating while the EDS is operating;
wherein the encoding subsystem encrypts the video monitoring subsystem output signal;
wherein the storage subsystem stores the encrypted video monitoring subsystem output signal;
wherein when the event trigger subsystem detects the event, the control subsystem instructs the storage subsystem to preserve a pre-event data segment and a post-event data segment;
wherein if the event renders the video monitoring subsystem inoperable, then storage subsystem's complete storage capacity is used to store the pre-event data segment; and
wherein the encrypted video monitoring subsystem output signal can be decrypted only by a database storage service bureau which has been certified to maintain accurate and authentic data.

2. The EDS of claim 1, wherein the event trigger subsystem further comprises an environmental change detection subsystem.

3. The EDS of claim 2, wherein the event trigger subsystem further comprises a mechanical force detection subsystem.

4. The EDS of claim 2, wherein the event trigger subsystem further comprises a flow change detection subsystem.

5. The EDS of claim 2, wherein the event trigger subsystem further comprises a pressure change detection subsystem.

6. The EDS of claim 1, wherein the monitored area further comprises a vehicle's trajectory.

7. The EDS of claim 6 further comprising a vehicle monitoring subsystem having an output signal representing one or more of the vehicle's operating characteristics.

8. The EDS of claim 1 further comprising a transmitter capable of transmitting the encrypted video monitoring subsystem output signal to the database storage service bureau.

9. The EDS of claim 1, wherein the event trigger subsystem further comprises a panic switch for manual triggering.

10. The EDS of claim 1, wherein the video monitoring subsystem further comprises a camera installed on a vehicle's exterior.

11. The EDS of claim 1, wherein the monitored area further comprises real property.

12. The EDS of claim 1, wherein the monitored area further comprises a construction apparatus.

13. The EDS of claim 1, wherein the monitored area further comprises a cargo container.

14. The EDS of claim 1 further comprising a receiver capable of receiving a command from a remote party instructing the EDS to take one or more actions.

15. The EDS of claim 14, wherein the one or more actions further comprises disabling a subsystem.

16. The EDS of claim 14, wherein the one or more actions further comprises activating a subsystem.

17. A method of documenting an event in a monitored area, the method comprising:
operating a video monitoring subsystem having an output signal representing an image of the monitored area continuously;
encrypting the video monitoring subsystem output signal via an encoding subsystem;
storing the encrypted video monitoring subsystem output signal in a storage subsystem;
instructing the storage subsystem to preserve a pre-event data segment and a post-event data segment when an event trigger subsystem detects the event;
preserving in the storage subsystem's entire storage capacity a pre-event data segment if the event renders the video monitoring subsystem inoperable; and
permitting the encrypted video monitoring subsystem output signal to be decrypted only by a database storage service bureau which has been certified to maintain accurate and authentic data.

18. An event documenting system (EDS) functioning to document an event in a monitored area, the EDS comprising:
a video monitoring subsystem having an output signal representing an image of the monitored area;
an event trigger subsystem capable of detecting the event;
an encoding subsystem capable of encrypting the video monitoring subsystem output signal;
a transmission subsystem capable of transmitting the video monitoring subsystem output signal to a remote site;
a control subsystem capable of controlling the EDS;
wherein the video monitoring subsystem is continuously operating while the EDS is operating;
wherein the encoding subsystem encrypts the video monitoring subsystem output signal;
wherein the transmission subsystem transmits the encrypted video monitoring subsystem output signal to the remote site at a predetermined time interval; and
wherein the encrypted video monitoring subsystem output signal can be decrypted only by a database storage service bureau which has been certified to maintain accurate and authentic data.

19. A method of documenting a medical or dental conference and a medical or dental procedure, the method comprising:
operating a video monitoring subsystem covering a pre-procedure medical or dental conference;
operating the video monitoring subsystem during the medical or dental procedure;
encrypting the video monitoring subsystem output signal via an encoding subsystem;
storing the encrypted video monitoring subsystem output signal in a storage subsystem capable of storing the video monitoring subsystem output signal; and
permitting the encrypted video monitoring subsystem output signal to be decrypted only by a database storage service bureau which has been certified to maintain accurate and authentic data.

20. The method of documenting a medical or dental conference and a medical or dental procedure of claim 19 further comprising operating the video monitoring subsystem during a post-procedure data collection session.

21. A method of documenting a legal proceeding, the method comprising:
operating a video monitoring subsystem having an output signal representing an image of the legal proceeding during the legal proceeding;
encrypting the video monitoring subsystem output signal via an encoding subsystem;
storing the encrypted video monitoring subsystem output signal in a storage subsystem capable of storing the video monitoring subsystem output signal; and
permitting the encrypted video monitoring subsystem output signal to be decrypted only by a database storage service bureau which has been certified to maintain accurate and authentic data.

22. A method of documenting an economic transaction, the method comprising:
providing a database storage service bureau which has been certified to maintain accurate and authentic data;
authenticating and recording an end user's order via the database storage service bureau;
authenticating and recording an invoice corresponding to the end user's order via the database storage service bureau;
authenticating and recording shipment of property corresponding to the invoice via the database storage service bureau;
authenticating and recording the end user's payment of a bill via the database storage service bureau; and
permitting stored records of the economic transaction to be accessed only by the database storage service bureau.

23. A method of documenting a construction project, the method comprising:
providing a database storage service bureau which has been certified to maintain accurate and authentic data;
verifying data related to the construction project via the database storage service bureau;
encrypting the data related to the construction project;
creating a documentary of the construction project by storing the encrypted data related to the construction project in a database associated with the construction project maintained by the database storage service bureau;
providing read only access to the database for the construction project maintained by the database storage service bureau to a first group of parties; and
providing read and write access to the database for the construction project maintained by the database storage service bureau to a second group of parties.

24. A portable apparatus functioning to document and facilitate the delivery of cargo, the portable apparatus comprising:
a keyboard to capture character data;
a bank card interface to capture bank card data;
an identification card interface to capture identification card data;
a communication interface to connect to an external communication network;
a user interface for a user to acknowledge acceptance or rejection of the cargo;
an optical screen for displaying data;
wherein an operator may document transfer of the cargo via the keyboard;
wherein the user may be identified via the identification card interface;
wherein the operator may be identified via the identification card interface;
wherein the user may purchase cargo via the bank card interface;
wherein the user may acknowledge receipt of the cargo via the user interface; and
wherein the operator may transfer data comprised by the portable apparatus to the external communication network via the communication interface.
